(19) United States
(12) Patent Application Publication
(10) Pub. No.: US 2003/0100283 A1
(43) Pub. Date: May 29, 2003

(54) Frequency acquisition and locking detection circuit for phase lock loop

(75) Inventors: Miaochen Wu, Acton, MA (US); Xiangdong Zhang, Westford, MA (US); Angelos Alexanian, Somerville, MA (US); Wei Ye, Westford, MA (US)

Correspondence Address: Leo R. Reynolds, Esq., HAMILTON, BROOK, SMITH & REYNOLDS, P.C., 530 Virginia Road, P.O. Box 9133, Concord, MA, 01742-9133, US

(73) Assignee: Narad Networks, Inc., Westford, MA (US)

(21) Appl. No.: 10/010,063

(22) Filed: Nov. 13, 2001

(51) Int. Cl. H04B 1/06

(52) U.S. Cl. 455/258; 455/260

(57) ABSTRACT

A method and apparatus for providing frequency acquisition and locking detection for a phase lock loop is disclosed. The phase lock loop locks a receiver local oscillator to the frequency and phase of an RF carrier to allow data to be recovered from the RF carrier in the receiver. An analog mixer in the phase lock loop compares the frequency and phase of a receive LO output by a voltage controlled oscillator in the phase lock loop and the received RF carrier. A locking indicator dependent on the result of the comparison indicates whether the phase lock loop is locked. The locking indicator is coupled to a comparator. The comparator generates a pulse to close a switch in order to inject a periodic sweeping signal generated by a free running multi vibrator into the phase lock loop to push the receiver LO into the locking range.

### RELATED APPLICATIONS

This application is related to Attorney Docket No. 3070.1009-000 entitled “Automatic Gain Control Circuit With Multiple Input Signals” by Miaochen Wu, Attorney Docket No.: 3070.1010-000 entitled “Differential Slicer Circuit for Data Communication”, by Miaochen Wu, and Attorney Docket No.: 3070.1011-000 entitled “Slicer Circuit With Ping Pong Scheme For Data Communication”, by Dev Gupta, et al., filed on even date herewith. The entire teachings of the above applications are incorporated herein by reference.

### BACKGROUND OF THE INVENTION

A broadband modem typically transmits data at data rates greater than 10 Mbps over a coaxial cable. A cable modem can use Quadrature Amplitude Modulation (QAM) to obtain a high data rate. Quadrature Amplitude Modulation (QAM) is a method for doubling effective bandwidth by combining two Amplitude Modulated carriers in a single channel. Each of the two carriers in the channel has the same frequency but differs in phase by 90 degrees. One carrier is called the In-phase (I) signal and the other carrier is called the Quadrature (Q) signal.

The receiver recovers the I and Q carriers from the received QAM signal and extracts the data from each carrier. To recover the carriers, the frequency of a receive clock provided by a local oscillator in a receiver must be locked to the frequency of the carriers transmitted by a transmitter. Typically, a Phase Lock Loop (PLL) is provided to stabilize the center frequency of the received signal and lock the local oscillator to the frequency of the carriers in the QAM signal. In the phase lock loop, an analog mixer is used as a phase detector because other types of commonly used phase detectors are not practical due to the high frequency.

However, the analog mixer can only achieve the phase and frequency locking within a very narrow frequency range. In theory, the transmitter and receiver have the same frequency. However, in the real world, the transmitter and receiver frequency differ because of crystal reference accuracy, drift, aging, temperature and power supply. In addition, the transmitter and receiver may have different operating temperatures. Thus, the frequency gap between the received QAM signal carrier and the local oscillator varies. If there is a large difference in frequency, the local oscillator may never lock to the frequency of the carriers and thus the data cannot be recovered from the channel.

One known method for locking the frequency of the local oscillator in a phase lock loop to the frequency of the carriers is through the use of a quadrature correlator. The voltage level on the output of the quadrature correlator coupled to the phase lock loop increases or decreases the frequency of the local oscillator. The voltage level on the output of the quadrature correlator can differ greatly between packets resulting in spikes in the voltage level, large variations in the frequency of the local oscillator and delay in locking to the carrier frequency. The quadrature correlator is sensitive to offsets, component mismatches and accuracy. Also, the quadrature correlator can inject noise into the phase lock loop after the phase lock loop is locked in phase with the received QAM signal.

### SUMMARY OF THE INVENTION

In accordance with the present invention, a receiver has locking detection and acquisition apparatus and a phase lock loop. The locking detection and aquistition apparatus detects when a phase lock loop is outside a locking range and injects a signal to push the phase lock loop into the locking range. The apparatus includes a comparator, a multi-vibrator and a switch. The window comparator is coupled to a locking indicator signal in the phase lock loop. A voltage level on the locking indicator indicates whether the phase lock loop is outside a locking range. The comparator monitors a voltage level on the locking indicator signal and generates a pulse to close a switch when the phase lock loop is outside the locking range. The multi-vibrator continuously generates a sweeping signal. The switch couples the sweeping signal generated by the multi-vibrator to the phase lock loop to push the phase lock loop inside the locking range.

The sweeping signal generated by the multi-vibrator can be periodic. The frequency of the periodic sweeping signal is lower than the frequency of a receive signal monitored by the phase lock loop. The periodic sweeping signal can be a triangular waveform, a square waveform or a sinusoidal waveform. The frequency of the periodic sweeping signal is generally at least one hundred times less than that of the receive signal input to the phase lock loop. In one embodiment, the period of the periodic sweeping signal is 1200 milli seconds and the period of the receive signal is 10 micro seconds.

The locking indicator can be an output of a differential amplifier in the phase lock loop and the comparator is coupled to the locking indicator. The switch includes three terminals, a first terminal of the switch is coupled to the phase lock loop and a second terminal of the switch is coupled to the multi-vibrator. The switch close signal from the comparator is coupled to a third terminal of the switch. The second terminal of the switch is coupled to the non-inverting input of a comparator in an integrator in the phase lock loop.

The comparator generates the pulse on the switch close signal during a frame synchronization period in a received frame while the voltage level of the locking indicator is outside the locking range of the phase lock loop. In one embodiment, a common mode voltage level is 2.5 volts and a voltage level in the range 2.4 to 2.6V on the locking indicator signal is within the locking range.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an embodiment of a network configuration of intelligent network elements for providing point-to-point data links between intelligent network elements in a broadband, bidirectional access system;

FIG. 2 is a block diagram of an embodiment of any one of the network elements shown in FIG. 1.

FIG. 3 is a diagram of a frame structure for use in the network of FIG. 1;

FIG. 4 is a block diagram of a receiver in any of the modems in the network element shown in FIG. 3.

FIG. 5 is a block diagram of a Frequency Acquisition Circuit and phase lock loop in the carrier recovery phase lock loop shown in FIG. 4 according to the principles of the present invention;

FIG. 6 is a circuit diagram of the differential amplifier and loop integrator in the PLL shown in FIG. 5;

FIG. 7 is a circuit diagram of the frequency acquisition and locking circuit shown in FIG. 5;

FIG. 8A is a timing diagram illustrating signals in the frequency acquisition circuit and the PLL shown in FIG. 5; and

FIG. 8B is an expanded portion of the timing diagram shown in FIG. 8A.

### DETAILED DESCRIPTION OF THE INVENTION

A description of preferred embodiments of the invention follows.

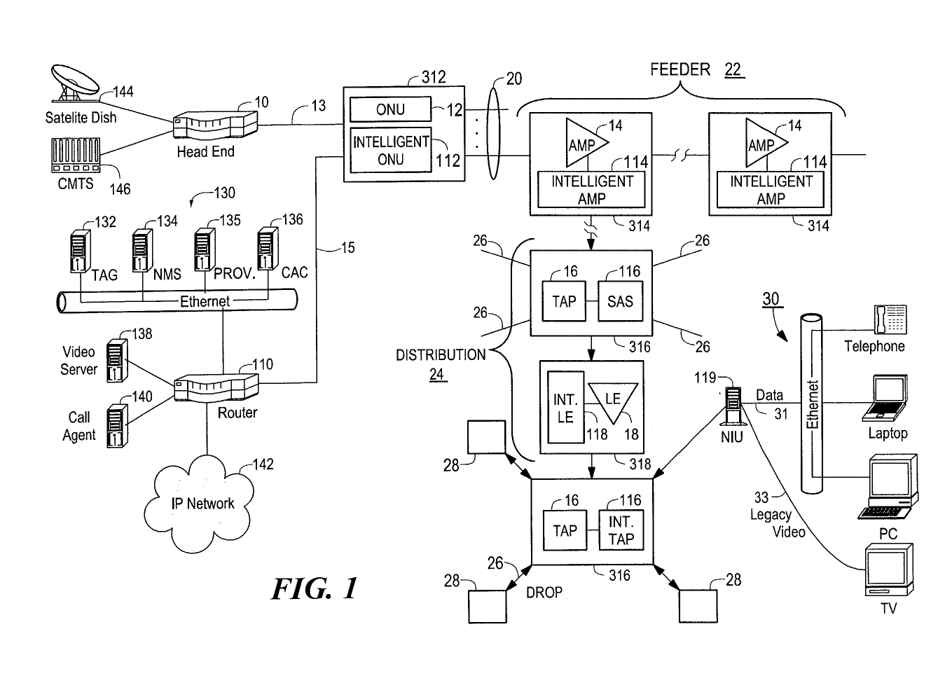

FIG. 1 illustrates an embodiment of a network configuration of intelligent network elements for providing point to point data links between intelligent network elements in a broadband, bidirectional access system. This network configuration is described in U.S. patent application Ser. No. 09/952,321 filed Sep. 13, 2001 entitled “Broadband System With Topology Discovery”, by Gautam Desai, et al, the entire teachings of which are incorporated herein by reference. The network configuration, also referred to herein as an Access Network, includes intelligent network elements each of which uses a physical layer technology that allows data connections to be carried over coax cable distribution facilities from every subscriber. In particular, point-to-point data links are established between the intelligent network elements over the coax cable plant. Signals are terminated at the intelligent network elements, switched and regenerated for transmission across upstream or downstream data links as needed to connect a home to the headend.

The intelligent network elements are interconnected using the existing cable television network such that the point-to-point data links are carried on the cable plant using bandwidth that resides above the standard upstream/downstream spectrum. For example, the bandwidth can reside at 1025 to 1125 MHZ (upstream) and 1300 to 1400 MHZ (downstream) or 100 Mbps upstream and downstream bandwidths can be provided in the spectrum 750 to 860 MHZ or duplexing channel spectrums can be allocated in the 777.5 MHz to 922.5 MHz regime for 100 Mb/s operation and in the 1 GHz to 2 GHz regime for 1 Gb/s operation.

The intelligent network elements include an intelligent optical network unit or node 112, intelligent trunk amplifier 114, intelligent tap or subscriber access switch (SAS) 116, intelligent line extender 118 and network interface unit (NIU) 119. A standard residential gateway or local area network 30 connected to the NIU 119 at the home is also shown. Note that the trunk amplifier 114 is also referred to herein as a distribution switch (DS). The configuration shown includes ONU assembly 312 comprising standard ONU 12 and intelligent ONU 112 also referred to herein as an optical distribution switch (ODS). Likewise, trunk amplifier or DA assembly 314 includes conventional trunk amp 14 and intelligent trunk amp 114; cable tap assembly 316 includes standard tap 16 and subscriber access switch 116; and line extender assembly 318 includes standard line extender 18 and intelligent line extender 118.

The intelligent ONU or ODS is connected over line 15 to a router 110, which has connections to a server farm 130, a video server 138, a call agent 140 and IP network 142. The server farm 130 includes a Tag/Topology server 132, a network management system (NMS) server 134, a provisioning server 135 and a connection admission control (CAC) server 136, all coupled to an Ethernet bus which are described in U.S. patent application Ser. No. 09/952,321 filed Sep. 13, 2001 entitled “Broadband System With Topology Discovery”, by Gautam Desai, et al, the entire teachings of which are incorporated herein by reference.

A headend 10 is shown having connections to a satellite dish 144 and CMTS 146. To serve the legacy portion of the network, the headend 10 delivers a conventional amplitude modulated optical signal to the ONU 12. This signal includes the analog video and DOCSIS channels. The ONU performs an optical to electrical (O/E) conversion and sends radio frequency (RF) signals over feeder coax cables 20 to the trunk amplifiers or DAs 14. Each DA along the path amplifies these RF signals and distributes them over the distribution portion 24.

The present system includes intelligent network elements that can provide high bandwidth capacity to each home. In the Access Network of the present invention, each intelligent network element provides switching of data packets for data flow downstream and statistical multiplexing and priority queuing for data flow upstream. The legacy video and DOCSIS data signals can flow through transparently because the intelligent network elements use a part of the frequency spectrum of the coax cable that does not overlap with the spectrum being used for legacy services.

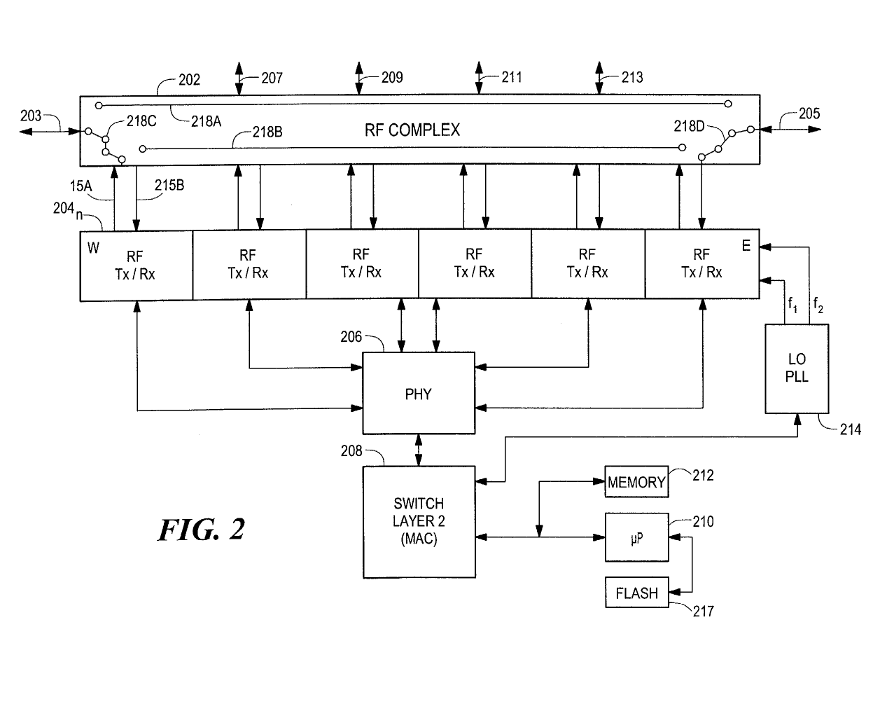

FIG. 2 is a block diagram of an embodiment of any one of the network elements shown in FIG. 1. The network element includes an RF complex 202, RF transmitter/receiver pairs or modems 204a-204n, a PHY (physical layer) device 206, a switch 208, microprocessor 210, memory 212, flash memory 217 and a local oscillator/phase locked loop (LO/PLL) 214. All of the components are common to embodiments of the ODS, DS, SAS and NIU shown in FIG. 1. The ODS further includes an optical/electrical interface. The NIU further includes a 100BaseT physical interface for connecting to the Home LAN 30 (FIG. 2). In addition, the RF complex is shown as having a bypass path 218A and a built in self test path 218B controlled by switches 218C, 218D which are described further herein.

The number of modems, 204n generally, depends on the number of links that connect to the network element. For example, DS 314 (FIG. 1) has five ports and thus has five modems 204. A SAS 316 (FIG. 1) has six ports and thus has six modems 204. The network element in FIG. 2 is shown having six ports indicated as ports 203, 205, 207, 209, 211 and 213.

The PHY device 206 provides physical layer functions between each of the modems 204 and the switch 208. The switch 208, controlled by the microprocessor 210, provides layer 2 switching functions and is referred to herein as the Media Access Control (“MAC”) device or simply MAC. The LO/PLL 214 provides master clock signals to the modems 204 at the channel frequencies.

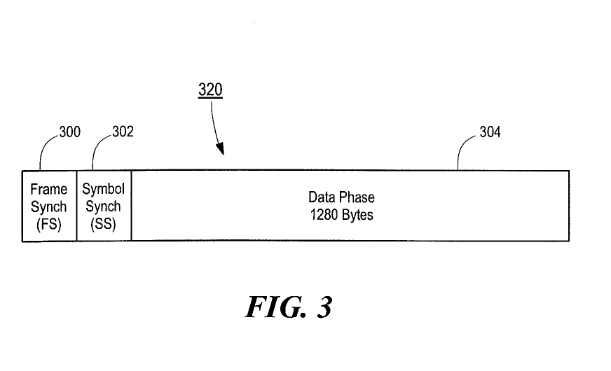

A modulation system with spectral efficiency of 4 bits/s/Hz is used in the RF modem 604n (FIG. 3) to provide high data rates within the allocated bandwidth. In particular, 16-state Quadrature Amplitude Modulation (16-QAM) is preferably used, which involves the quadrature multiplexing of two 4-level symbol channels. Embodiments of the network elements of the present system described herein support 100 Mb/s and 1 Gb/s Ethernet transfer rates, using the 16-QAM modulation at symbol rates of 31 or 311 MHZ.

FIG. 3 is a block diagram of a frame structure 320 for use in the network of FIG. 1. The frame structure 320 is used to transmit a frame over the network. The frame structure 320 includes frame synchronization 300, symbol synchronization 302 and a data phase 304. In a particular embodiment, frame and symbol synchronization is performed every 10 micro seconds (μs) followed by 1280 bytes of Data Phase 621, with frame synchronization (FS) 300 for 1 μs and the symbol synchronization (SS) 302 for 400 nano seconds (ns). It should be understood that other frame structures are possible and the frame structure described is only an example.

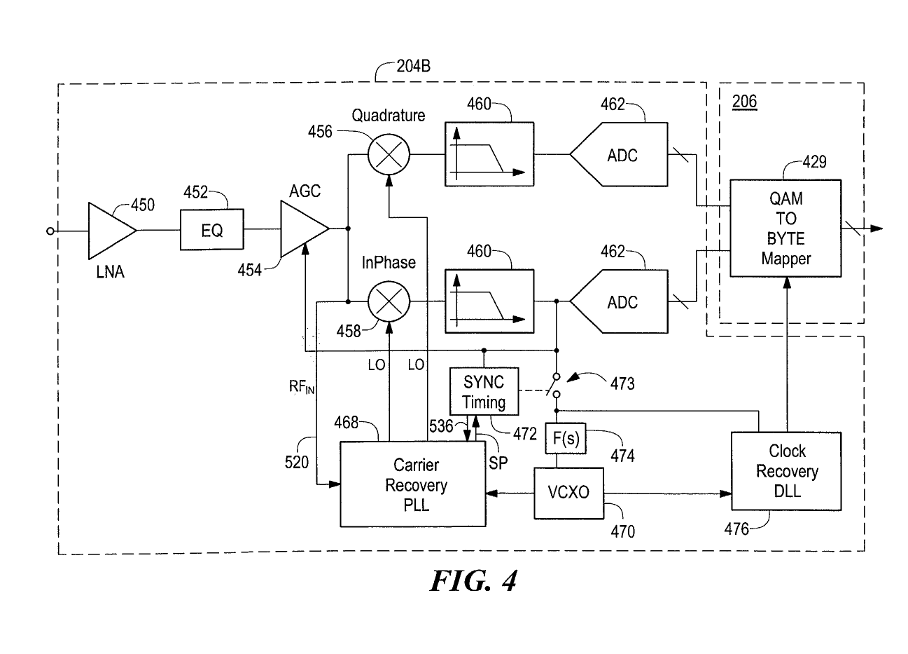

FIG. 4 is a block diagram of a receiver 204B in any of the modems 204 in the network element shown in FIG. 2. The receiver 204B receives a quadrature-multiplexed signal which includes in-phase (I) and quadrature (Q) carriers. At the front end, the receiver section 204B includes low-noise amplifier (LNA) 450, equalizer 452 and automatic gain control (AGC) 454. The received signal from PHY 206 (FIG. 2) is boosted in the LNA 450 and corrected for frequency-dependent line loss in the equalizer 452. The equalized signal is passed through the AGC stage 454 to I and Q multiplier stages 456, 458, low pass filters 460 and analog-to-digital converters (ADC) 462. After down-conversion in the multiplier stages 456, 458 and low-pass filtering, the I and Q channels are digitized and passed on to the QAM-to-byte mapper 429 for conversion to a byte-wide data stream in the PHY device 406 (FIG. 2).

Carrier and clock recovery, for use in synchronization at symbol and frame levels, are performed during periodic training periods. A carrier recovery PLL circuit 468 provides the I and Q carriers from the RF carrier (RFin) 520 to the multipliers 456, 458. The RF carrier 520 includes the I and Q carriers. A clock recovery delay locked loop (DLL) circuit 476 provides a clock to the QAM-to-byte mapper 449. During each training period, PLL and DLL paths that include F(s) block 474 and voltage controlled oscillator (VCXO) 470 are switched in using normally open switch 473 under control of SYNC timing circuit 472 in order to provide updated samples of phase/delay error correction information.

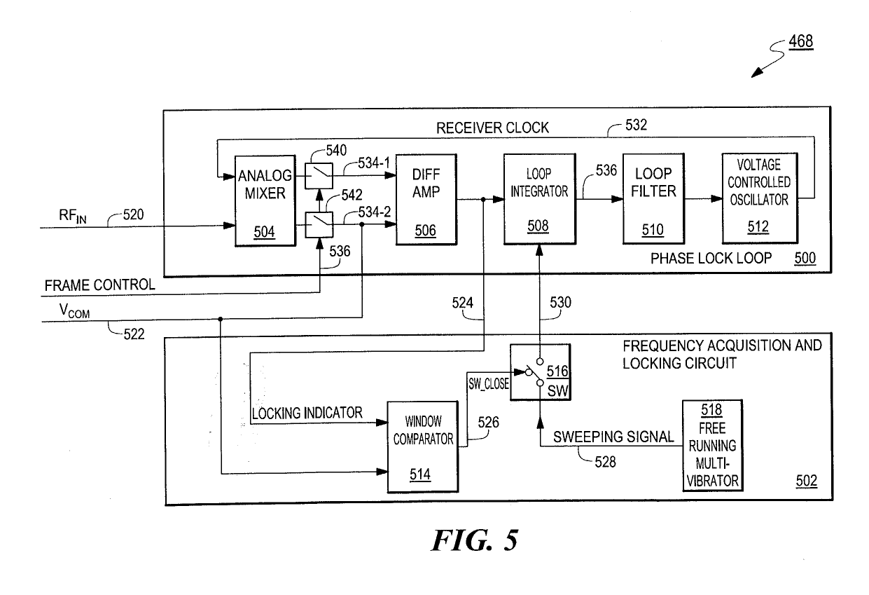

FIG. 5 is a block diagram of a frequency acquisition and locking circuit 502 and phase lock loop 500 in the carrier recovery phase lock loop 468 shown in FIG. 4 according to the principles of the present invention. The Phase Lock Loop (“PLL”) 500 is a feedback loop including an analog mixer 504, a differential amplifier 506, a loop integrator 508, a loop filter 510 and a Voltage Controlled Oscillator (“VCO”) 512. The analog mixer 504 is used as a phase detector, to detect the phase and frequency difference between the RF carrier 520 and a receiver LO 532 output by the VCO 512.

The phase lock loop 500 is closed and the analog mixer 504 is coupled to the differential amplifier 506 in the phase lock loop 500 while sample and hold switches 540, 542 are closed by the frame control signal 536 output by the SYNC timing circuit 472 (FIG. 4). Switches 540, 542 are closed by frame control 536 only during frame synchronization 300 of each received frame 320. During frame synchronization 300 only the I and Q carriers are received on the RF carrier 520. Thus, the phase lock loop 500 is closed during frame synchronization 300 to allow the phase lock loop to lock to the RF carrier 520 so that data can be recovered during the data phase 304 of each received frame 320.

The analog mixer 504 can only achieve phase and frequency locking within a narrow frequency range. For example, the narrow frequency range can be +/− 10 kilo hertz (Khz). The frequency acquisition and locking circuit 502 assists the PLL 500 in frequency acquisition and locking when the frequency of the RF carrier 520 is outside of the narrow frequency range of the analog mixer 504. The voltage level on the input of the VCO 512 is dependent on the phase and frequency difference detected by the analog mixer 504. The VCO 512 increases or decreases the frequency of the receiver Local Oscillator (LO) 532 dependent on the input voltage level. By feeding back the receiver LO 532 to the analog mixer 504 to compare with the RF carrier 520, the VCO can “lock on” to the frequency of the RF carrier 520 by providing a receiver LO 532 equal in frequency and 90° out of phase with the RF carrier 520.

The VCO 512 has an associated locking range and capture range. For example, for a VCO having a control voltage range of 0-5V and frequency range of 2-2.3 Ghz, the capture range is typically 100 Khz and the locking range is typically 50 Khz. The locking range is the range of frequencies that the VCO can track the RF carrier 520 after locking has occurred. If the VCO 512 has not locked to the frequency of the RF carrier 520, the voltage level of the control voltage on the input of the VCO 512 is increased or decreased to cause the VCO 512 to sweep in order to allow the VCO to lock. While the receiver LO 532 is locked to the RF carrier 520, the VCO 512 can remain locked and follow slow changes in the frequency and phase of the RF carrier 520.

The analog mixer 504 generates a differential voltage on output signals 534-1, 534-2 which can be positive, zero or negative dependent on the frequency and phase difference between the receiver LO 532 and the RF carrier 520. Thus, the frequency of the receiver LO 532 can vary above or below the center frequency of the VCO 512. While the frequency of the RF carrier 520 is within the locking range and the phase difference is 90°, the differential voltage between output signals 534-1, 534-2 is zero. The voltage level on the input of the VCO 512 keeps the VCO 512 locked to the frequency of the RF carrier 520 and 90° out of phase with the RF carrier 520.

The differential amplifier 506 amplifies the differential voltage between signals 534-1, 534-2 to provide a voltage level on the locking indicator signal 524 dependent on the differential voltage. The loop integrator 508 acts like a loop filter by filtering out high frequency signals. The loop filter 510 performs further filtering on signal 536 output by the loop integrator 508 to provide a direct current (D.C.) voltage level at the input of the VCO 512 to control the frequency of the receiver LO 532.

The frequency acquisition and locking circuit 502 includes a window comparator 514, a free running multi-vibrator 518 and a switch 516. The switch 516 is normally open. The locking indicator 524 is coupled to the window comparator 514. A common mode voltage V_{COM} 522 is coupled to both the window comparator 514 and to the differential amplifier 506 in the PLL 500. The common mode voltage is set to a D.C. voltage half way between the power rails. In an embodiment in which the power rails are 5V and 0V, the common mode voltage is 2.5V. The common mode voltage eliminates the effect of any common mode voltage difference between the phase lock loop 500 and the frequency acquisition and locking circuit 502.

The window comparator 514 determines if the voltage level on the locking indicator 524 is within a predefined voltage window. The voltage window is dependent on the frequency range of the analog mixer 504. If the voltage level on the locking indicator 524 is outside the predefined voltage window, the window comparator 514 generates a pulse on sw_close 526 to close the switch 516. The switch 516 is under the control of sw_close 526 and closed by a low voltage level on sw_close 526. In one embodiment, the low voltage level is 0V.

The free running multi-vibrator 518 continuously generates a sweeping signal 528. In one embodiment the sweeping signal is a periodic triangular or saw-shaped waveform. However, the invention is not limited to the triangular-shaped waveform. In other embodiments, the sweeping signal 528 can be a sinusoidal waveform or even a square waveform. The frequency of the sweeping signal 528 is lower than the frame rate on the RF carrier 520.

In one embodiment, the frequency of frame synchronization for the RF carrier 520 is 120,000 times faster than that of the sweeping signal 528. The frequency of the sweeping signal 528 is slower than the frame rate on the RF carrier 520 so that the phase lock loop 500 is not pushed in the correct or incorrect direction too often. Pushing the phase lock loop 500 in the correct or incorrect direction too quickly can result in the phase lock loop 500 never being pushed into the locking range.

The switch 516 can be a CMOS ADG 722 or ADG 723 switch manufactured by Analog Devices or any other CMOS switch or CMOS transistors with similar properties. While the switch 516 is closed by the sw_close signal 526, the output of the free running multi-vibrator 528 is coupled to the loop integrator 508 to push the VCO 512 into the locking range. The sweeping signal 528 pushes the VCO 512 into the locking frequency range by increasing or decreasing the voltage level on the input of the VCO 512 to modify the frequency of the receiver LO 532. The sweeping signal 528 can push the VCO 512 in the correct direction or the incorrect direction dependent on the voltage level on the sweeping signal. Thus, the voltage level on the input of the VCO 512 is dependent on the voltage level of the sweeping signal while the sweeping signal is coupled to the phase lock loop 500 through the switch 516.

After the VCO 512 is locked, the voltage level of the locking indicator 524 at the output of the differential amplifier 506 falls within the predefined voltage window of the window comparator 514. As a result, the switch 516 is open and the output of the free running multi-vibrator 518 is disconnected from the loop integrator 508. Thus, the frequency acquisition circuit 502 is coupled to the PLL 500 only while the frequency of the RF carrier 520 is outside of the pull-in range of the PLL 500 during frame synchronization of each received frame.

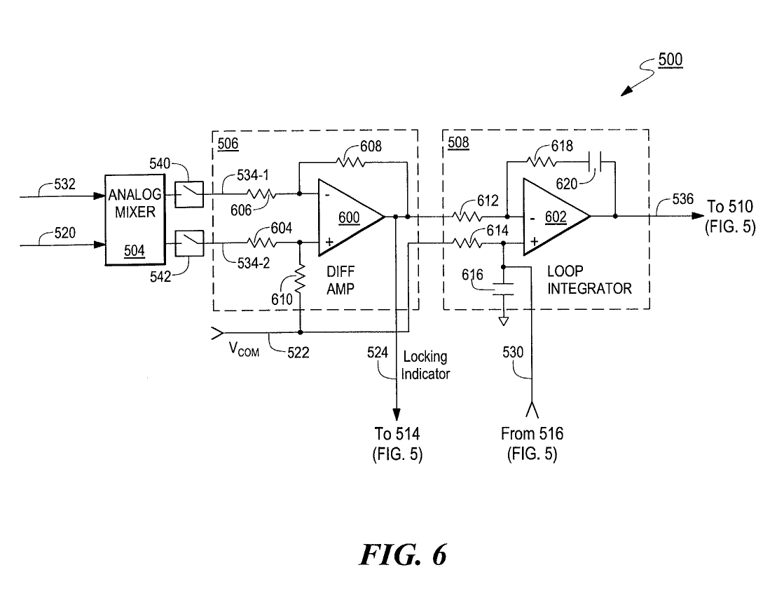

FIG. 6 is a circuit diagram of the differential amplifier 506 and loop integrator 508 in the PLL 500 shown in FIG. 5. Differential amplifier 506 includes amplifier 600, input resistors 606, 604 and 610 and feedback resistor 608. The voltage level on locking indicator signal 524, the output of amplifier 600 is an indication of whether the PLL 500 is locked.

Input resistor 606 is coupled between the differential output 534-1 of analog mixer 504 and the inverting input of amplifier 600. Input resistor 604 is coupled between the differential output 534-2 of the analog mixer 504 and the non-inverting input of amplifier 600. Feedback resistor 608 is coupled between locking indicator 524 and the inverting input of the amplifier 600. Input resistor 610 is coupled between the non-inverting input of amplifier 600 and common mode voltage Vcom 522.

In one embodiment, the input resistors 606, 604 and 610 and feedback resistor 608 are all 10 Kilo ohms (KΩ). Thus, the voltage level on locking indicator 524 is dependent on the difference in voltage between the voltage at the non-inverting input and the voltage at the inverting input.

The voltage at the non-inverting input of differential amplifier 600 is also dependent on the common mode voltage V_{COM}. The common mode voltage Vcom 522 is coupled to the differential amplifier 600 through resistor 610 so that the output voltage level of the differential amplifier is half the power supply voltage when there is no differential voltage between the non-inverting input and the inverting input.

The loop integrator includes an amplifier 602 with negative feedback between the loop integrator output 536 and the negative input. The negative feedback includes a capacitor 620 and a resistor 618 connected in series with one end of the capacitor 620 coupled to the output of the amplifier 602 and one end of the resistor 618 coupled to the inverting input of the amplifier 602. The negative feedback filters out high frequency signals.

The sweeping signal 528 coupled to the loop integrator 602 through the switch 516 is integrated by the loop integrator 602. The loop integrator 602 acts as a first order filter to filter high frequency signals. However, a first order filter is not sufficient to filter all high frequency signals. Thus, the loop integrator output signal 536 is further filtered by the loop filter 510 (FIG. 5) to filter higher order frequencies to provide rejection of high frequency noise and provide a D.C. voltage level.

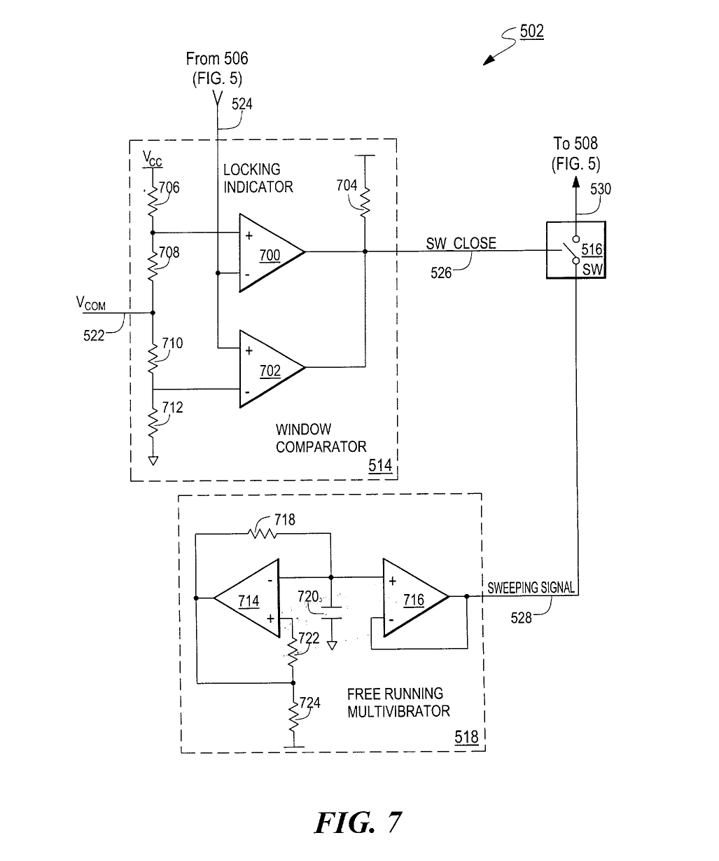

FIG. 7 is a circuit diagram of the frequency acquisition and locking circuit 502 shown in FIG. 5. The window comparator 514 generates a pulse on the sw_close signal 526 to close the normally open single pole, single throw switch 516. The switch 516 is open when the PLL 500 (FIG. 5) is within the locking range and closed by the sw_close signal 526 during frame synchronization of each received frame while the PLL is outside the locking range.

The window comparator 514 includes two differential amplifiers 700, 702. The inverting input of 700 and the non-inverting input of 702 are coupled to the locking indicator signal 524 in the phase lock loop 500. The non-inverting input of differential amplifier 700 and the inverting input of differential amplifier 702 are coupled to a voltage divider. The voltage divider includes resistors 706, 708, 710 and 712. The common mode voltage 522 is coupled to resistors 708 and 710. As previously described, the common mode voltage is a D.C. voltage level half way between the power supply rails.

In one embodiment, one power supply rail V⁺ is 5V, the other power supply rail V⁻ is 0V and the common mode voltage V_{COM} 522 is 2.5V (½(V⁺−V⁻)). The values of resistors 706, 708, 710 and 712 are selected so that there is a 100 millivolts (mV) voltage drop across resistor 708 and a 100 mV voltage drop across resistor 710. Thus, with the common mode voltage V_{COM} at 2.5V, the voltage at the non-inverting input of differential amplifier 700 is 2.6V and the voltage at the inverting input of differential amplifier 702 is 2.4V. The voltage window is 2.6V to 2.4V. Thus, the frequency locking and acquisition circuit 502 is only coupled to the PLL 500, if the voltage level of the locking indicator 524 is greater than 2.6V or less than 2.4V. In alternate embodiments, the width of the voltage window can be changed by selecting different values for resistors 708 and 710, for example, such that a voltage drop of 150 mV exists across each of resistors 708 and 710 to provide a 2.65V to 2.35V voltage window.

While the PLL 500 is not locked, the window comparator 514 generates at least one pulse on the sw_close signal 512 during frame synchronization of each received frame. The total number of the pulses that are generated to push the PLL into the locking range represent how far the frequency and phase of the receiver LO 532 is from the RF carrier 520 (FIG. 5). The number of pulses generated per received frame is dependent on the voltage level on the locking indicator signal during frame synchronization. A pulse is generated each time the voltage level on the locking indicator moves outside the voltage window. Typically, one pulse is generated per frame.

In an embodiment in which the common mode voltage Vcom is 2.5V and the voltage drop across each resister is 0.1V, the PLL is locked while the voltage level on the locking indicator signal 524 is within the voltage window; that is, between 2.4V and 2.6V. While the voltage level on the locking indicator signal 524 is between 2.4V and 2.6V, the voltage level on the output of both differential amplifier 700 and differential amplifier 702 is 5V. Differential amplifier 700 compares voltage level of the locking indicator signal with 2.6V. Differential amplifier 702 compares the voltage level on the locking indicator signal with 2.4V. Both differential amplifiers 700, 702 are open collector. Thus, a voltage level of 0V on the output of either differential amplifier 700, 702 results in a voltage level of 0V on the sw_close signal 526. The voltage level on the sw_close signal 526 is dependent on the voltage level on the locking indicator signal 524 as shown in Table 1 below.

TABLE 1

| locking indicator | sw_close |
|---|---|
| 2.4 V-2.6 V | 5 V |
| >2.6 V | 0 V |
| <2.4 V | 0 V |

If the voltage level on the locking indicator signal is greater than 2.6V, the voltage level on the inverting input of comparator 700 is greater than the voltage level on the non-inverting input of comparator 700 resulting in a voltage level of 0V on the sw_close signal 526.

If the voltage level on the locking indicator signal is less than 2.4V, the voltage level on the inverting input of comparator 702 is greater than the voltage level on the non-inverting input of comparator 702, resulting in 0V on the sw_close signal 526. The open collector outputs of comparators 700 and 702 are coupled to resistor 704 such that 0V on the output of either comparator 700 or comparator 702 results in a voltage level of 0V on the sw_close signal 526 as shown below in Table 2 below.

TABLE 2

| Comparator 700 | | | Comparator 702 | | | |
|---|---|---|---|---|---|---|
| − | + | OUT | − | + | OUT | sw_close |
| >2.6 | 2.6 | 0 | 2.4 | >2.6 | 5 | 0 |
| <2.4 | 2.6 | 5 | 2.4 | <2.4 | 0 | 0 |
| 2.4-2.6 | 2.6 | 5 | 2.4 | 2.4-2.6 | 5 | 5 |

The free running multi-vibrator 518 generates a sweeping signal 528 which is coupled to one of the inputs of the switch 516. The sweeping signal 528 is coupled to the loop integrator 508 (FIG. 5) in the PLL 500 (FIG. 5) through the switch 516 while the switch 516 is closed. The switch 516 is closed during frame synchronization of a received frame if the PLL 500 is outside of the locking range. The free running multi-vibrator 518 outputs a sweeping signal 528 with a voltage level ranging from the maximum power supply voltage to the minimum power supply voltage. The sweeping signal is injected into the loop integrator 508 (FIG. 5) while the switch is closed by the pulse on the sw_close signal.

In the embodiment shown, the sweeping signal 528 is generated by differential amplifier 714 configured to generate a periodic triangular wave and buffered through buffer 716. The periodic triangular wave signal switches between the power supply rails. For example, if one power supply rail is 5V and the other power supply rail is 0V, the periodic triangular wave signal switches between 5V and 0V.

The frequency of the periodic sweeping signal 528 generated by amplifier 714 is dependent on the values of resistor 718 and capacitor 720. In one embodiment, resistor 724 is 100 Kilo ohms (KΩ), resistor 722 is 1KΩ, resistor 718 is 100KΩ and capacitor 720 is 10 micro Farads to provide a triangular wave with a frequency about 120,000 times slower than the frequency of frame synchronization for the RF carrier 520 (FIG. 5).

While the PLL 500 is locked, the voltage level on the locking indicator signal 524 is 2.5V. The window comparator 514 no longer generates a pulse because the voltage level on the locking indicator signal 524 is inside the voltage window. Thus, the sw_close signal 526 is about 5 volts. The sweeping signal 528 is disconnected from the PLL because the switch is open. The PLL operates normally under lock operation. If the PLL goes out of lock, for example, due to noise or a power surge, the sweeping signal 528 output from the free running multi-vibrator 518 is once again coupled through the switch 516 to the loop integrator 508 to push the PLL inside the locking range.

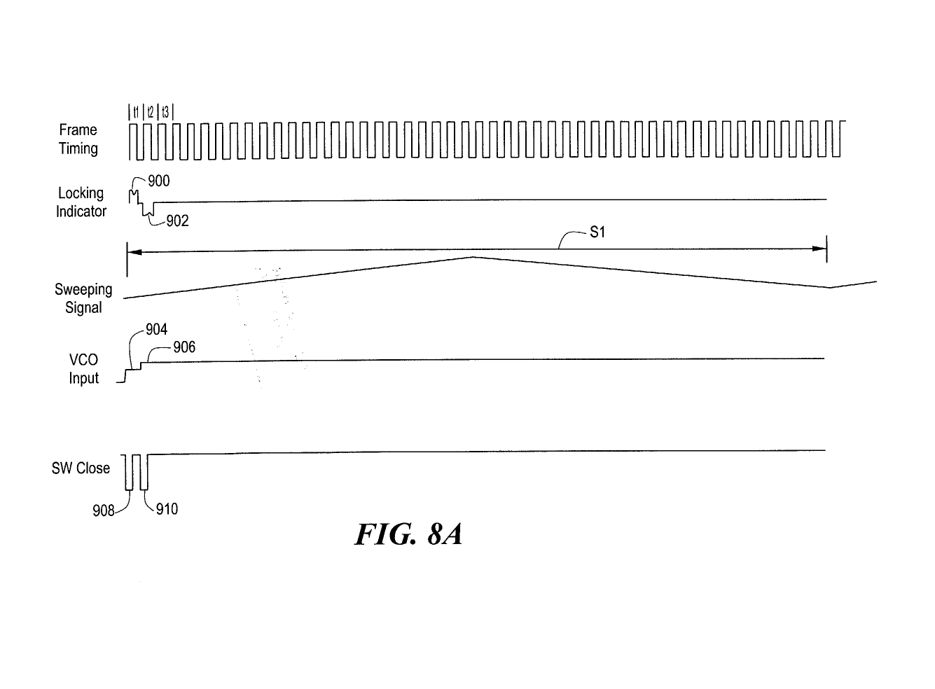

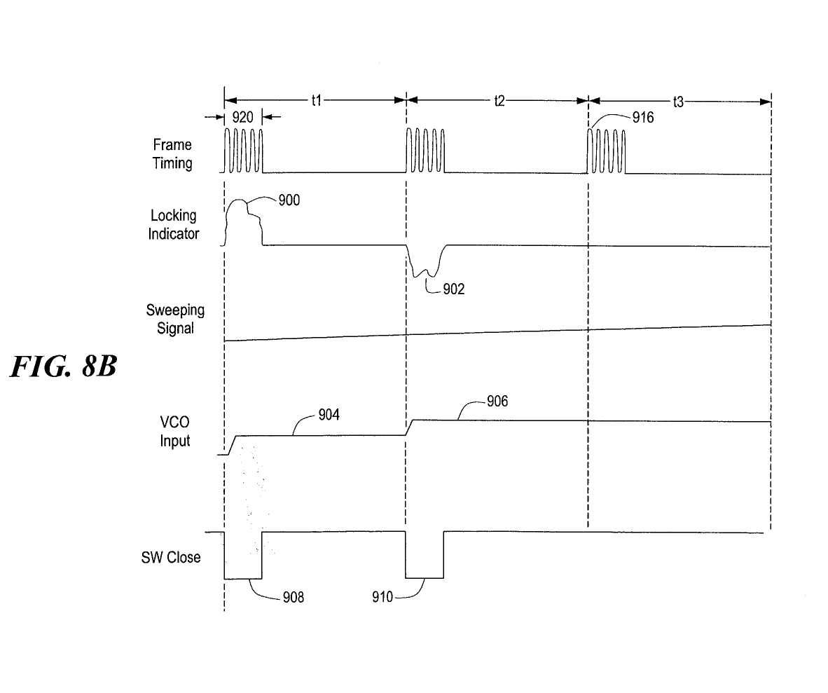

FIG. 8A is a timing diagram illustrating signals in the frequency acquisition and locking circuit 502 and the PLL 500 shown in FIG. 5. FIG. 8A is described in conjunction with FIG. 5 and FIG. 3. A frame structure received by the receiver in each frame period t1, t2, t3. The frame structure 320 has already been described in conjunction with FIG. 3. Each frame structure 320 includes frame synchronization 300. During frame synchronization in each frame structure, switches 540 and 542 are closed to allow the analog mixer 532 in the phase lock loop 500 to compare the receive LO 532 and the RF carrier 520. Based on the differential voltage output by the analog mixer, the differential amplifier 506 outputs a voltage level on the locking indicator signal 524. The voltage level is dependent on the phase and frequency difference between the receive LO 532 and the RF carrier 520. As discussed previously, the voltage level is about 2.4V to 2.6V while the PLL is within the locking range. The voltage level can vary during frame synchronization dependent on the frequency and phase difference.

As shown in FIG. 8A, at the beginning of frame period t1, a voltage level 900 greater than 2.5V is output on the locking indicator signal 524. At the beginning of frame period t2, a voltage level 902 less than 2.4V is output on the locking indicator signal 524. In the example shown, the sweeping signal 528 is a periodic saw-shaped waveform with a slow rising and falling edge. The voltage level at the input of the VCO 512 is increased or decreased dependent on the voltage level on the sweeping signal 528 while the switch is closed.

A voltage level on the locking indicator signal 524 outside the voltage window defined by the window comparator indicates that the PLL 500 not locked. A voltage level 900, 902 on the locking indicator signal 524 triggers the window comparator 514 to generate a pulse on the sw_close signal 526 to close the switch. A pulse 908 is generated in frame period t1 due to voltage level 900 and a pulse 910 is generated in frame period t2 due to voltage level 902. Each pulse 908, 910 on the sw_close signal 526 closes the switch 516 to couple the sweeping signal 526 to the loop integrator 506 in the phase lock loop 500.

In the example shown, the voltage level of the locking indicator signal varies above 2.6V and below 2.4V but does not move inside the 2.4V-2.6V voltage window during frame synchronization. Thus, the window comparator 514 outputs one pulse per received frame. However, the window comparator 514 can output more than one pulse per frame if the voltage level on the locking indicator signal moves inside and then moves outside the 2.4V-2.6V window during frame synchronization.

The loop integrator 508 is either pushed in the correct voltage direction or the incorrect direction dependent on the voltage level of the sweeping signal 528 while the switch is closed. The loop integrator 508 receives a pushing voltage level each time the switch 516 is closed until the correct voltage level is provided to the input VCO 512. After the phase lock loop 500 is locked, the sweeping signal 528 is no longer coupled to the loop integrator 508 because the voltage level on the locking indicator signal 528 is within the voltage window and the sw_close signal is about 5V. In frame synchronization in frame period t3, the voltage level on the locking indicator signal is about 2.5V indicating that the VCO 512 is locked.

In the example shown, the frequency acquisition and locking circuit 502 pushes the phase lock loop 500 into the locking range after receiving two frames and closing the switch 516 once per received frame. However, it may take up to one period of the sweeping signal to achieve lockup dependent on whether the voltage level on the sweeping signal is pushing the phase lock loop in the correct or the incorrect direction. In the example shown, the rising edge of the sweeping signal pushes the voltage level of the VCO input in the correct direction by increasing the voltage level on the input of the VCO 512. However, if locking required the voltage level to be decreased instead of increased, the sweeping signal would push the voltage level in the incorrect direction by increasing the voltage level during the rising edge of the sweeping signal. The VCO input would not be pushed in the correct direction until during the falling edge of the sweeping signal.

FIG. 8B is an expanded portion of the timing diagram shown in FIG. 8A. As shown, the positive pulse 908, 910 on the sw_close signal 526 is output only during frame synchronization 920 of the respective frame period t1, t2. The switch 512 is closed during pulses 908, 910. At the end of frame synchronization 920 in frame period t1 and t2, the voltage on the locking indicator signal returns to about 2.5V, resulting in the rising edge of pulses 908 and 910. The switch 512 is opened during the remainder of each frame period t1, t2 to decouple the sweeping signal from the phase lock loop.

While this invention has been particularly shown and described with references to preferred embodiments thereof, it will be understood by those skilled in the art that various changes in form and details may be made therein without departing from the scope of the invention encompassed by the appended claims.

What is claimed is:

1. A receiver having locking detection and frequency acquisition apparatus and a phase lock loop, the locking detection and frequency acquisition apparatus comprising:
a comparator coupled to a locking indicator signal in the phase lock loop, a voltage level on the locking indicator signal indicating whether the phase lock loop is outside a locking range, the comparator monitoring the voltage level on the locking indicator signal and generating a pulse to close a switch when the phase lock loop is outside the locking range; and
a multi-vibrator which continuously generates a sweeping signal, the switch coupling the sweeping signal of the multivibrator to the phase lock loop to push the phase lock loop inside the locking range.

2. The apparatus as claimed in claim 1 wherein the sweeping signal is periodic.

3. The apparatus as claimed in claim 2 wherein the frequency of the periodic sweeping signal is lower than the frequency of a receive signal monitored by the phase lock loop.

4. The apparatus as claimed in claim 2 wherein the periodic sweeping signal is a triangular waveform.

5. The apparatus as claimed in claim 2 wherein the periodic sweeping signal is a square waveform.

6. The apparatus as claimed in claim 2 wherein the periodic sweeping signal is a sinusoidal waveform.

7. The apparatus as claimed in claim 3 wherein the frequency of the periodic sweeping signal is at least one hundred times lower than the frequency of received frames on the receive signal.

8. The apparatus as claimed in claim 7 wherein the period of the periodic sweeping signal is 1200 milli seconds and the period of the received signal is 10 microseconds.

9. The apparatus as claimed in claim 1 wherein the comparator generates a plurality of pulses until the phase lock loop is within the locking range.

10. The apparatus as claimed in claim 1 wherein the locking indicator is an output of a differential amplifier in the phase lock loop and the switch is coupled to an integrator in the phase lock loop.

11. The apparatus as claimed in claim 9 wherein the switch includes three terminals, a first terminal of the switch coupled to the phase lock loop and a second terminal of the switch coupled to the multivibrator, the switch close signal from the comparator coupled to a third terminal of the switch.

12. The apparatus as claimed in claim 10 wherein a second terminal of the switch is coupled to the integrator in the phase lock loop.

13. The apparatus as claimed in claim 12 wherein the second terminal of the switch is coupled to the non-inverting input of a comparator in the integrator in the phase lock loop.

14. The apparatus as claimed in claim 1 wherein the comparator generates the pulse on the switch close signal during a frame synchronization period in a received frame while the voltage level of the locking indicator signal is outside the locking range of the phase lock loop.

15. The apparatus as claimed in claim 14 wherein a common mode voltage level is 2.5 volts and a voltage level in the range 2.4-2.6 volts on the locking indicator signal is within the locking range.

16. A method for providing locking detection and frequency acquisition for a phase lock loop in a receiver comprising:
monitoring a voltage level of a locking indicator signal in the phase lock loop;
generating a pulse to close a switch, upon detecting from the voltage level on the locking indicator signal that the phase lock loop is outside a locking range;
continuously generating a sweeping signal; and
injecting the sweeping signal into the phase lock loop while the switch is closed to push the phase lock loop inside the locking range.

17. The method as claimed in claim 16 wherein the sweeping signal is periodic.

18. The method as claimed in claim 17 wherein the frequency of the periodic sweeping signal is lower than the frequency of a receive signal monitored by the phase lock loop.

19. The method as claimed in claim 18 wherein the periodic signal is a triangular waveform.

20. The method as claimed in claim 18 wherein the periodic signal is a square waveform.

21. The method as claimed in claim 18 wherein the periodic sweeping signal is a sinusoidal waveform.

22. The method as claimed in claim 18 wherein the frequency of the periodic sweeping signal is at least one hundred times lower than the frequency of received frames on the receive signal.

23. The method as claimed in claim 22 wherein the period of the periodic sweeping signal is 1200 milli seconds and the period of the received signal is 10 microseconds.

24. The method as claimed in claim 18 wherein a plurality of pulses are generated for a plurality of received frames until the phase lock loop is within the locking range.

25. The method as claimed in claim 18 wherein the pulse on the switch close signal is generated during a frame synchronization period in a received frame while the voltage level of the locking indicator signal is outside the locking range of the phase lock loop.

26. The method as claimed in claim 25 wherein a common mode voltage level is 2.5 volts and a voltage level in the range 2.4-2.6 volts on the locking indicator signal is within the locking range.

27. A receiver having locking detection and frequency acquisition apparatus and a phase lock loop, the locking detection and frequency acquisition apparatus comprising:
a comparator coupled to a locking indicator signal in the phase lock loop, a voltage level on the locking indicator signal indicating whether the difference between the frequency of a local oscillator in the phase lock loop and the frequency of a received signal is outside a predefined locking range, the comparator monitoring the voltage level on the locking indicator signal and generating a pulse to close a switch when the phase lock loop is outside the locking range; and
a multi-vibrator which continuously generates a sweeping signal, the switch coupling the sweeping signal of the multivibrator to the phase lock loop to push the phase lock loop inside the locking range by modifying an input voltage level to the local oscillator to modify the frequency of the local oscillator.

28. A locking detection and frequency acquisition apparatus for pushing a phase lock loop into a locking range, the locking detection and frequency acquisition apparatus comprising:
a comparator coupled to a locking indicator signal in the phase lock loop, a voltage level on the locking indicator signal indicating whether the difference between the frequency of a local oscillator in the phase lock loop and the frequency of a received signal is outside the predefined locking range, the comparator monitoring the voltage level on the locking indicator signal and generating a pulse to close a switch when the phase lock loop is outside the locking range; and
a multi-vibrator which continuously generates a sweeping signal, the switch coupling the sweeping signal of the multivibrator to the phase lock loop to push the phase lock loop inside the locking range by modifying an input voltage level to the local oscillator to modify the frequency of the local oscillator.
